(19) United States
(12) Patent Application Publication
(10) Pub. No.: US 2026/0298301 A1
(43) Pub. Date: Oct. 1, 2026

(54) RESIN COMPOSITION, BRAKE ROTOR, SET FOR PREPARING BRAKE ROTOR, METHOD OF PRODUCING BRAKE ROTOR, AND BRAKE

(71) Applicant: RESONAC CORPORATION, Minato-ku, Tokyo (JP)

(72) Inventors: Katsuyuki MASUDA, Shinjuku-ku, Tokyo (JP); Yasuhiro HARA, Shinjuku-ku, Tokyo (JP); Keiichiro NISHIMURA, Tokyo (JP)

(21) Appl. No.: 19/480,738

(22) PCT Filed: Sep. 18, 2024
(86) PCT No.: PCT/JP2024/033344

§ 371 Date: Oct. 31, 2025

(30) Foreign Application Priority Data
Sep. 25, 2023 (WO) PCT/JP2023/034788

(51) Int. Cl. F16D 69/02; C08K 3/11; C08K 3/22; C08L 63/08; C09D 7/61; C09D 163/08; F16D 69/00

(52) U.S. Cl. CPC F16D 69/025; C08K 3/11; C08K 3/22; C08L 63/08; C09D 7/61; C09D 163/08; C08K 2003/2237; F16D 2069/003

(57) ABSTRACT

A resin composition for use in coating a sliding surface of a brake rotor, the resin composition containing at least one compound selected from the group consisting of a titanium compound, a magnesium compound, and a lithium compound, and an epoxy resin or a precursor thereof.

### TECHNICAL FIELD

The present disclosure relates to a resin composition, a brake rotor, a set for preparing a brake rotor, a method of producing a brake rotor, and a brake.

### BACKGROUND ART

A disc brake used in an automobile, a two-wheeled vehicle, or the like is a member in which a disc rotor is sandwiched between two brake linings, and braking is applied by friction between the two brake linings.

Generally, the brake rotor is made of cast iron or stainless steel, and a surface on which the brake lining and the brake rotor slide against each other is finished by grinding. As an example, a configuration diagram of a brake rotor is shown in FIG. 1. In a brake rotor 10 of FIG. 1, a sliding surface 1 becomes a new surface by sliding with a brake pad during use of a brake, but rust is generated on a rotor side surface 2 and a fastening surface 3. Therefore, a high molecular weight resin-based coating composition having high heat resistance as shown in Patent Document 5 may be applied to the rotor side surface 2 or the fastening surface 3.

Rust may be generated on the sliding surface of the brake rotor during the period from production to use of a vehicle. When rust is generated, the brake pad and the brake rotor become stuck together, and the brake rotor becomes difficult to rotate, or vibration called a brake judder occurs due to a difference in rust thickness on the brake rotor between the portions covered with the brake pad and the other portions. Therefore, as described in Patent Document 1, dacrotized treatment or the like is sometimes applied to the sliding surface of the brake rotor.

In order to make the sliding surface of the brake rotor in use less likely to rust, Patent Document 2 proposes that the surface of the brake rotor is nitrided to increase rust prevention capability. Patent Documents 3 and 4 propose that a rust preventive coating material such as a reducing compound is applied to a brake rotor or the like to prevent rust.

Patent Document 6 proposes applying a coating agent containing a highly heat-resistant resin and a solid lubricant to a disc brake component such as a disc rotor. For example, the coating agent is applied to the sliding surface of the disc rotor.

### CITATION LIST

### Patent Documents

Patent Document 1: Japanese Patent Application Laid-Open (JP-A) No. 2002-323073
Patent Document 2: Japanese Patent Application Laid-Open (JP-A) No. 2016-164439
Patent Document 3: Japanese Patent Application Laid-Open (JP-A) No. 2004-510924
Patent Document 4: Japanese Patent No. 5706197
Patent Document 5: Japanese Patent Application Laid-Open (JP-A) No. 2017-508023
Patent Document 6: WO 2005/080515 A

### SUMMARY OF INVENTION

### Technical Problem

The braking force of the disc brake is obtained by the frictional force between the brake rotor and the brake lining, but the two members have poor conformity with each other at the initial stage (for example, when the two members are new). Usually, the initial state of the brake rotor surface is pure iron, but since a transfer film from the friction material is formed on the surface layer in the process of use, the friction coefficient, wear, and the like are stabilized. Therefore, it is necessary to perform braking several hundred times or more in order to obtain originally designed brake frictional force.

In Patent Document 1, dacrotized treatment is applied to a brake rotor for the purpose of rust prevention of the sliding surface during the period from production to use of a vehicle. In Patent Documents 5 and 6, coating is performed with a polymeric resin-based paint, and these components are present on the surface of the brake rotor for a long period of time. In these cases, it takes more time until the original frictional characteristics obtained by the brake rotor and the brake lining are exhibited as compared with the case of an untreated rotor. The coated component may remain on the sliding surface, destabilize the friction coefficient, and cause abnormal noise. It is desirable not to apply the compositions described in Patent Documents 5 and 6 having excellent coatability to the sliding surface. The sliding surface changes to a new surface by sliding with the brake pad during use of the brake, and thus rust prevention during the period from production to use of the vehicle is more important than at the time of use. Therefore, a resin composition capable of producing a brake rotor that exhibits a rust prevention effect on the sliding surface during the period from production to use of the vehicle and has excellent stability of an initial friction coefficient during use of the brake is desirable.

In the case of a nitrided coating film as in Patent Document 2 or a rust preventive coating material such as a reducing compound as in Patent Documents 3 and 4, the members of the brake rotor and the brake lining fit poorly together at the initial stage, similarly to a brake rotor without such treatments. Therefore, it is necessary to perform braking several hundred times or more in order to obtain originally designed brake frictional force. The nitrided coating film is maintained for a long period of time while maintaining the frictional characteristics, but the change in the frictional characteristics is large when the coating film disappears and the inside cast iron appears. In addition, another problem is that the dacrotized treatment and the nitriding treatment have a high treatment cost.

In recent years, since electric vehicles have become widespread and the battery mass has increased, brakes have also become larger in order to secure braking force in an emergency. However, the regenerative brake reduces the brake load under normal conditions. For this reason, it is problem that it takes time for the braking force to reach the designed braking force. On the other hand, automatic driving of automobiles is being promoted, and if a constant braking force cannot always be obtained, the vehicle does not decelerate as designed, which is a further problem.

The present disclosure has been made in view of the above conventional circumstances, and an object of the present disclosure is to provide a resin composition capable of producing a brake rotor having excellent rust prevention effect on a sliding surface during the period from production to use of the vehicle and excellent stability of an initial friction coefficient, a set for preparing a brake rotor, and a method of producing a brake rotor.

Another object of the present disclosure is to provide a brake rotor having excellent rust prevention effect and stability of an initial friction coefficient, and a brake equipped with the brake rotor.

### Solution to Problem

Concrete means for achieving the objects are as follows.
<1> A resin composition for use in coating a sliding surface of a brake rotor, the resin composition including at least one compound selected from the group consisting of a titanium compound, a magnesium compound, and a lithium compound, and an epoxy resin or a precursor thereof.
<2> The resin composition according to <1>, in which the compound is a titanium compound.
<3> The resin composition according to <1> or <2>, in which the titanium compound is at least one selected from the group consisting of titanium oxide and titanium black.
<4> The resin composition according to any one of <1> to <3>, in which a content of the compound is from 25% by mass to 90% by mass with respect to a total solid content.
<5> The resin composition according to any one of <1> to <4>, in which the epoxy resin or the precursor thereof has an epoxy equivalent of 1000 g/eq or less.
<6> The resin composition according to any one of <1> to <5>, in which the epoxy resin or the precursor thereof contains a bisphenol-type epoxy resin or a precursor thereof.
<7> A brake rotor, including a sliding surface provided with a metal-containing layer formed from the resin composition according to any one of <1> to <6>.
<8> A set for preparing a brake rotor, the set including:
at least one compound selected from the group consisting of a titanium compound, a magnesium compound, and a lithium compound,
an epoxy resin or a precursor thereof, and
a rotor member.
<9> A method of producing a brake rotor using the set for preparing a brake rotor according to <8>, the method including:
forming a metal-containing layer by applying a resin composition containing the compound and the epoxy resin or the precursor thereof to a sliding surface of the rotor member.
<10> A brake, including the brake rotor according to <7> and a brake pad.
<11> The brake according to <10>, in which the metal-containing layer has a thickness of from 1 μm to 100 μm.
<12> The brake according to <10> or <11>, in which the brake rotor is made of cast iron, and is subjected to at least one surface treatment selected from grinding, polishing, or machining.
<13> The brake according to any one of <10> to <12>, in which the brake pad is a non-asbestos organic material pad.

### Advantageous Effects of Invention

According to an embodiment of the present disclosure, a resin composition capable of producing a brake rotor having excellent rust prevention effect during the period from production to use of the vehicle and excellent stability of an initial friction coefficient, a set for preparing a brake rotor, and a method of producing a brake rotor can be provided.

According to an embodiment of the present disclosure, a brake rotor having excellent rust prevention effect and excellent stability of an initial friction coefficient, and a brake equipped with the brake rotor can be provided.

### BRIEF DESCRIPTION OF DRAWINGS

FIG. 1 is a configuration diagram of a brake rotor.

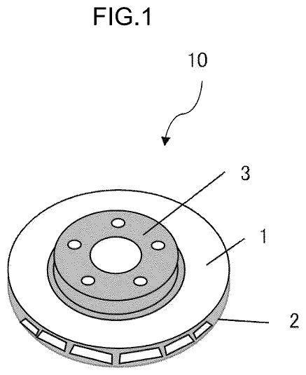

### DESCRIPTION OF EMBODIMENTS

Hereinafter, embodiments for carrying out the present disclosure will be described in detail. However, the present disclosure is not limited to the following embodiments. In the following embodiments, the components (also including element steps and the like) are not essential unless otherwise specified. The same applies to numerical values and ranges thereof, and these do not limit the present disclosure.

In the present disclosure, a numerical range indicated by “to” includes numerical values described before and after “to” as the lower value and upper value, respectively.

In the numerical ranges described in a stepwise manner in the present disclosure, the upper or lower limit value of one numerical range may be replaced with the upper or lower limit value of another numerical range described in a stepwise manner. In the numerical range described in the present disclosure, the upper or lower limit value may be substituted with a value shown in the Examples.

In the present disclosure, each component may include multiple types of corresponding substances. In a case in which multiple types of substances corresponding to each component are present in the composition, the content or amount of the each component means the total content or amount of the multiple types of substances present in the composition, unless otherwise specified.

In the present disclosure, the particles corresponding to each component may contain multiple types of particles. In a case in which multiple types of particles corresponding to each component are present in the composition, the particle diameter of the each component means a value for a mixture of the multiple types of particles present in the composition, unless otherwise specified.

In the present disclosure, the term “layer” includes not only a case in which the layer is formed in the entire region when the region where the layer is present is observed, but also a case in which the layer is formed only in a part of the region.

The average particle diameter of the particles refers to a 50% (median) diameter (D50) determined from a volume distribution of a particle size distribution measured by a laser diffraction/scattering particle diameter distribution measuring apparatus. The average particle diameter can be measured with LA-920 (manufactured by HORIBA, Ltd.), for example.

### [Resin Composition]

A resin composition of the present disclosure contains at least one compound selected from the group consisting of a titanium compound, a magnesium compound, and a lithium compound (hereinafter, the compound is also referred to as a “specific metal compound”), and an epoxy resin or a precursor thereof, and is used for coating a sliding surface of a brake rotor.

The resin composition of the present disclosure is used for coating a sliding surface of a brake rotor, and is preferably used to form a metal-containing layer on a sliding surface of a base of a brake rotor made of cast iron or stainless steel.

The specific metal compound preferably contains a titanium compound, and more preferably is a titanium compound.

Examples of the specific metal compound include a compound containing at least one cation selected from the group consisting of a titanium cation, a magnesium cation, and a lithium cation. Examples thereof include complex acid salts such as hydroxides, carbonates, sulfates, halides, oxides, and titanium complex acid salts, and organometallic compounds such as organometallic compounds containing titanium black or titanium.

The specific metal compound is preferably at least one selected from the group consisting of titanium oxide and titanium black. Titanium oxide is preferable from the viewpoint of easy availability, and titanium black is preferable from the viewpoint of coating in black.

Examples of the hydroxide include magnesium hydroxide and lithium hydroxide.

Examples of the carbonate include magnesium carbonate and lithium carbonate.

Examples of the sulfate include titanium sulfate and magnesium sulfate.

Examples of the halide include trichlorotitanium, tetrachlorotitanium, magnesium chloride, magnesium bromide, lithium chloride, and lithium bromide.

Examples of the oxide include titanium oxide and magnesium oxide.

The titanium complex acid salt is, for example, a titanium complex acid salt represented by the general formula of MₓO (titanium oxide)_{y}. In the general formula, MRO is an oxide containing a cation represented by M, and x and y are integers. Examples of the titanium complex acid salt include lithium titanate, magnesium titanate, lithium potassium titanate, titanocene, potassium titanate, and lithium potassium titanate.

Examples of the organometallic compound containing titanium include titanocene and bis(n5-cyclopentadienyl)-bis(2,6-difluoro-3-(1H-pyrrol-1-yl)-phenyl) titanium.

The specific metal compound is preferably a titanium compound, and from the viewpoint of shortening the time for friction stabilization, the titanium compound is preferably at least one selected from the group consisting of titanium oxide, titanium black, lithium titanate, potassium titanate, magnesium titanate, lithium potassium titanate, and titanocene.

The specific metal compound may be in the form of particles. In this case, the particle diameter of the specific metal compound is preferably 0.3 μm or more, more preferably from 0.3 μm to 50 μm, and still more preferably from 0.3 μm to 25 μm from the viewpoint of safety.

The content of the specific metal compound is preferably from 25% by mass to 90% by mass, more preferably from 30% by mass to 80% by mass, and still more preferably from 40% by mass to 70% by mass with respect to the total solid content.

The resin composition of the present disclosure contains an epoxy resin or a precursor thereof. Powder falling of a specific metal compound can be suppressed by using an epoxy resin or a precursor thereof in combination with the specific metal compound. Accordingly, in the brake rotor produced using the resin composition of the present disclosure, the rust prevention effect can also be suitably maintained.

The above-described epoxy resin or the precursor thereof is preferably dissolved in a liquid in which the powder is dissolved or dispersed.

Specific examples of the epoxy resin or the precursor thereof include bisphenol type epoxy resins such as bisphenol A type and bisphenol F type, phenol novolac type epoxy resins, cresol novolac type epoxy resins, zylok type epoxy resins, aliphatic type epoxy resins, glycidylamine type epoxy resins, naphthalene type epoxy resins, and biphenol type epoxy resins or their precursors. A bisphenol type epoxy resin or a precursor thereof is preferable, and a bisphenol A type or bisphenol F type epoxy resin or a precursor thereof is more preferable from the viewpoint of easy availability, excellent handleability, and enabling various coating forms of the resin composition.

The epoxy resin or the precursor thereof may be used singly, or in combination of two or more kinds thereof.

The epoxy equivalent of the epoxy resin or the precursor thereof is preferably 1000 g/eq or less, more preferably from 100 g/eq to 950 g/eq, and still more preferably from 150 g/eq to 900 g/eq from the viewpoint of thermal curing.

The epoxy equivalent of the epoxy resin or the precursor thereof is preferably 900 g/eq or less, more preferably 800 g/eq or less, still more preferably 600 g/eq or less, and particularly preferably 500 g/eq or less, from the viewpoint of superior rust prevention effect on the sliding surface during the period from production to use of the vehicle and excellent stability of an initial friction coefficient.

The lower limit of the epoxy equivalent of the epoxy resin or the precursor thereof is not particularly limited, and may be 100 g/eq or more or 150 g/eq or more.

When the epoxy equivalent of the epoxy resin or the precursor thereof is 900 g/eq or less, the fluctuation of the initial friction coefficient when the brake is used is suppressed. This is because the epoxy equivalent is not too high, so that the adhesion of the resin composition applied to the sliding surface is not too high. It is presumed that, during the period from production to use of the vehicle, this allows a rust prevention effect to be exhibited on the sliding surface, and that the fluctuation of the initial friction coefficient when the brake is used can be suppressed by the resin composition applied during the use of the brake being easily removed.

The resin composition of the present disclosure is preferably curable after coating from the viewpoint of preventing powder falling after coating and heat resistance. The curing may be either thermal curing or photocuring, and is preferably thermal curing from the viewpoint of simplicity of a curing device.

The resin composition of the present disclosure may contain a curing agent, a curing accelerator, and the like.

Examples of the curing agent include phenol-based, acid anhydride-based, and amine-based curing agents. Examples of the phenol-based curing agent include phenol novolac resins, cresol novolac resins, and phenol aralkyl resins. Examples of the acid anhydride-based curing agent include docesenyl succinic anhydride, polyazelaic anhydride, hexahydrophthalic anhydride, methyltetrahydrophthalic anhydride, methylnadic anhydride, trimellitic anhydride, pyromellitic anhydride, and benzophenonetetracarboxylic anhydride. Examples of the amine-based curing agent include dicyandiamide and melamine. In particular, dicyandiamide is preferably used because dicyandiamide can cope with various coating forms.

The ratio of the number of equivalents of reactive groups contained in the epoxy resin or the precursor thereof to the number of equivalents of reactive groups contained in the curing agent is preferably from 0.4 to 2.0 and more preferably from 0.6 to 1.2 from the viewpoint of sufficient curing.

Examples of the curing accelerator include tertiary amines, imidazoles, and phosphorus compounds. Examples of the tertiary amines include benzyldimethylamine, 2,4,6-tris(dimethylaminomethyl)phenol, and 1,8-diazabicyclo[5.4.0]undec-7-ene. Examples of the imidazoles include 2-methylimidazole, 2-ethyl-4-methylimidazole, 1-(2-cyanoethyl)-2-ethyl-4-methylimidazole, 1-(2-cyanoethyl)-2-phenylimidazole, and 2-heptadecylimidazole. Examples of the phosphorus compound include triphenylphosphine. These are appropriately selected depending on the curing temperature, and the imidazoles are preferable.

The content of the curing accelerator is preferably from 0.05% by mass to 5% by mass and more preferably from 0.1% by mass to 2% by mass with respect to the total mass of the epoxy resin or the precursor thereof, from the viewpoint of smoothly proceeding curing and obtaining a cured product having excellent strength.

The resin composition of the present disclosure may or may not contain other components other than a specific metal compound, an epoxy resin or a precursor thereof, a curing agent, and a curing accelerator.

Examples of the other components include other resins or their precursors other than the epoxy resin or the precursor thereof, a liquid, a polymerization initiator such as a thermal polymerization initiator or a photopolymerization initiator, a crosslinking agent, a sensitizer, a friction modifier, a viscosity modifier, an elastic modulus modifier, a surfactant, a leveling agent, a metal deactivator, a colorant such as charcoal, and a fragrance.

Examples of the other resins include a phenol resin, a urethane resin, a fluororesin, a polyester resin, an amide resin, an amideimide resin, an imide resin, a melamine resin, a urethane resin, a phenoxy resin, a silicone resin, a silicic acid-based resin, an acrylic resin, and an olefin resin. Examples of the precursors of other resins include precursors of these resins.

The other resins or their precursors may be each independently used singly, or in combination of two or more kinds thereof.

The resin composition of the present disclosure preferably contains a liquid in which a specific metal compound, a resin, or the like is dissolved or dispersed, from the viewpoint of forming a metal-containing layer having excellent film thickness uniformity. The total content of the specific metal compound may be appropriately adjusted depending on whether the specific metal compound is dissolved in the liquid or dispersed in the liquid.

The total content of the specific metal compound may be from 1% by mass to 80% by mass or from 5% by mass to 70% by mass with respect to the total amount of the resin composition, from the viewpoint of enabling spray coating and easily adjusting the film thickness.

Examples of the liquid include water, alcohol solvents, glycol solvents, ester solvents, ketone solvents, ether solvents, and aromatic solvents, and more specific examples thereof include diethyl ether, dimethyl ether, acetone, methyl ethyl ketone, diisobutyl ketone, ethyl acetate, methanol, ethanol, toluene, xylene, N-methylpyrrolidone, dimethylacetamide, and 1-methoxy-2-propanol.

In a case in which the resin or the precursor thereof contained in the resin composition is a thermosetting or photocurable material, the resin composition of the present disclosure may contain a polymerization initiator such as a thermal polymerization initiator or a photopolymerization initiator.

As the polymerization initiator, a commercially available radical polymerization initiator, a cation polymerization initiator, or the like can be used, and an organic peroxide, an azo radical polymerization initiator, or the like may be used.

As the radical photopolymerization initiator, bis(n5-cyclopentadienyl)-bis(2,6-difluoro-3-(1H-pyrrol-1-yl)-phenyl) titanium (for example, Irgacure784 manufactured by IGM Resins) may be used. This material can also serve as a photopolymerization initiator and a titanium compound.

The resin composition of the present disclosure may be a liquid material (for example, a liquid composition) or a powder material. From the viewpoint that a metal-containing layer having high uniformity can be formed and various application methods can be employed, the liquid material is preferable. Examples of a method of applying the powder material to the base of the brake rotor include powder application by spraying. Examples of the method of applying the liquid material to the base of the brake rotor include dispenser, spray, cast coating, and spin coating.

The ratio of the total amount of the epoxy resin and the precursor thereof to the total amount of the specific metal compounds (the epoxy resin and the precursor thereof/the specific metal compounds) may be from 0.2 to 10, from 0.5 to 8, or from 1 to 5 in terms of a mass ratio, from the viewpoint of suppressing powder falling and fading.

### [Brake Rotor]

A brake rotor of the present disclosure includes a sliding surface provided with a metal-containing layer formed from the above-described resin composition of the present disclosure.

The brake rotor of the present disclosure has excellent rust prevention effect and excellent stability of an initial friction coefficient. The reason is presumed as follows. A titanium compound, a magnesium compound, or a lithium compound enters the surface of the brake rotor and forms a dense metal-containing layer on the sliding surface, whereby rust prevention and stability of an initial friction coefficient are exhibited.

From the viewpoint of easily forming a dense metal-containing layer on the sliding surface in a low temperature region at the initial stage of friction, it is preferable to use a titanium compound.

In the brake rotor of the present disclosure, the friction coefficient is stabilized from around 100° C. to around 300° C. at the start of use of the brake rotor, particularly around 100° C., and the wear of a friction material such as a disc brake pad can be improved. As a result, wear powder can be reduced, and generation of environmental hazardous substances and human body harmful substances can be reduced. Furthermore, the use of environmental pollutants can be reduced. In addition, by the addition of a specific metal compound, a rust prevention effect during storage of the brake rotor is also exhibited.

In the brake rotor of the present disclosure, rust of the brake rotor at the time of being new is suppressed, and the number of times of braking until the braking force reaches a predetermined braking force can be reduced. As a result, even in an automobile such as an electric automobile in which a normal brake load is small, the time for obtaining a stable braking force can be shortened.

The brake rotor of the present disclosure is a brake rotor used in an automobile, a two-wheeled vehicle, and the like. The brake rotor may also be a disc rotor for a disc brake.

The brake rotor on which the metal-containing layer is formed is preferably made of cast iron and is subjected to at least one surface treatment selected from grinding, polishing, or machining. Examples of the machining include roller burnishing.

The amount of the specific metal compound contained in the metal-containing layer, that is, the amount of the specific metal compound supported per unit area of the sliding surface of the brake rotor depends also on the density of the specific metal compound, but is preferably from 0.01 mg/cm² to 25 mg/cm², and more preferably from 0.2 mg/cm² to 12.5 mg/cm², from the viewpoint of suitably exhibiting the effect of the invention and reducing the amount of the specific metal compound used.

When the metal-containing layer contains a resin, the specific metal compound is supported on the sliding surface. As a result, powder falling of the powder is suppressed, so that the rust prevention effect can also be suitably maintained.

The metal-containing layer may have a thickness of from 1 μm to 100 μm, or from 5 μm to 50 μm. When the metal-containing layer has a thickness of 1 μm or more, the rust prevention effect is suitably improved. When the metal-containing layer has a thickness of 100 μm or less, the time for friction stabilization can be shortened, and the resin from being carbonized by heating and causing a decrease in the friction coefficient called fading can be suppressed.

The total content of the specific metal compound may be from 10% by mass to 80% by mass, or from 20% by mass to 70% by mass, with respect to the total amount of the metal-containing layer.

### [Set for Preparing Brake Rotor]

A set for preparing a brake rotor of the present disclosure includes at least one compound selected from the group consisting of a titanium compound, a magnesium compound, and a lithium compound (specific metal compound), an epoxy resin or a precursor thereof, and a rotor member.

The set for preparing a brake rotor of the present disclosure is used for preparing a brake rotor. For example, the above-described resin composition of the present disclosure can be obtained using a specific metal compound and an epoxy resin or a precursor thereof, and a metal-containing layer can be formed by applying the resin composition to the sliding surface of the rotor member.

### [Method for Producing Brake Rotor]

A method of producing a brake rotor of the present disclosure is a method in which the set for preparing a brake rotor of the present disclosure or the resin composition of the present disclosure is used, and includes forming a metal-containing layer by applying the resin composition, or a resin composition containing the compound and the epoxy resin or the precursor thereof in the above-described set for preparing a brake rotor, to the sliding surface of the rotor member.

Examples of the method of forming the metal-containing layer on the sliding surface of the brake rotor include a method in which a powder containing a specific metal compound is attached to a base of the brake rotor, and a method in which a liquid composition obtained by dissolving or dispersing the powder in a liquid is applied to the base of the brake rotor. Examples of the method of applying the liquid composition to the base of the brake rotor include a method in which the liquid composition is coated by a dispenser, spray, cast coating, spin coating, or the like.

In a case in which the liquid composition is used, heating is preferably performed after applying the liquid composition in order to distill off the liquid. The heating temperature depends on the boiling point of the liquid in the liquid composition, but is preferably from a temperature of the boiling point minus 30° C. to a temperature of the boiling point plus 30° C.

A brake according to the present disclosure includes the above-described brake rotor of the present disclosure and a brake pad. The brake may include a disc rotor and a disc brake pad, and may be a brake used for an automobile, a two-wheeled vehicle, or the like.

The brake pad may be a member formed using a friction material obtained by molding a friction material composition and a back plate. A primer layer intended for surface modification for the purpose of enhancing an adhesion effect of the back plate to the friction material, and an adhesive layer intended for adhesion of the back plate to the friction material may be further interposed between the back plate and the friction material.

The brake pad may be a steel pad, a semi-steel pad, or an organic material pad, and is preferably a non-asbestos organic material pad from the viewpoint of making the effect clearer.

### EXAMPLES

Hereinafter, the present disclosure will be described more detail with reference to examples, but the present disclosure is not limited by these examples at all.

### (Preparation of Titanium Oxide Coating Liquid-1)

2 g of anatase-type titanium oxide (manufactured by FUJIFILM Wako Pure Chemical Corporation), 2 g of bisphenol A type liquid epoxy resin (trade name: EP850, manufactured by DIC Corporation, epoxy equivalent: about 190 g/eq), 100 mg of dicyandiamide (DICY), and 20 mg of 2-ethyl-4-methylimidazole were dissolved or dispersed in 14 g of 1-methoxy-2-propanol (solvent) to obtain a titanium oxide coating liquid-1 as a resin composition. Although titanium oxide precipitated over time, the titanium oxide coating liquid was sufficiently stirred immediately before use to disperse titanium oxide, and used.

### (Preparation of Titanium Oxide Coating Liquid-2)

2 g of anatase-type titanium oxide (manufactured by FUJIFILM Wako Pure Chemical Corporation), 2 g of bisphenol A type liquid epoxy resin (trade name: JER1001, manufactured by Mitsubishi Chemical Corporation, epoxy equivalent: about 475 g/eq), 40 mg of dicyandiamide (DICY), and 8 mg of 2-ethyl-4-methylimidazole were dissolved or dispersed in 14 g of 1-methoxy-2-propanol (solvent) to obtain a titanium oxide coating liquid-2 as a resin composition. Although titanium oxide precipitated over time, the titanium oxide coating liquid was sufficiently stirred immediately before use to disperse titanium oxide, and used.

### (Preparation of Titanium Oxide Coating Liquid-3)

2 g of anatase-type titanium oxide (manufactured by FUJIFILM Wako Pure Chemical Corporation), 2 g of bisphenol A type liquid epoxy resin (trade name: EP3050, manufactured by DIC Corporation, epoxy equivalent: about 800 g/eq), 24 mg of dicyandiamide (DICY), and 4.8 mg of 2-ethyl-4-methylimidazole were dissolved or dispersed in 18.2 g of 1-methoxy-2-propanol (solvent) to obtain a titanium oxide coating liquid-2 as a resin composition. Although titanium oxide precipitated over time, the titanium oxide coating liquid was sufficiently stirred immediately before use to disperse titanium oxide, and used.

### (Preparation of Titanium Oxide Coating Liquid-4)

2 g of anatase-type titanium oxide (manufactured by FUJIFILM Wako Pure Chemical Corporation), 2 g of bisphenol A type liquid epoxy resin (trade name: EP4050, manufactured by DIC Corporation, epoxy equivalent: about 950 g/eq), 20 mg of dicyandiamide (DICY), and 4 mg of 2-ethyl-4-methylimidazole were dissolved or dispersed in 14 g of 1-methoxy-2-propanol (solvent) to obtain a titanium oxide coating liquid-4 as a resin composition. Although titanium oxide precipitated over time, the titanium oxide coating liquid was sufficiently stirred immediately before use to disperse titanium oxide, and used.

### (Preparation of Epoxy Coating Liquid)

2 g of bisphenol A type liquid epoxy resin (trade name: EP850, manufactured by DIC Corporation, epoxy equivalent: about 190 g/eq), 100 mg of dicyandiamide (DICY), and 20 mg of 2-ethyl-4-methylimidazole were dissolved or dispersed in 14 g of 1-methoxy-2-propanol (solvent) to obtain an epoxy coating liquid.

### (Preparation of Polyacrylic Acid Solution (A))

A flask equipped with a stirrer, a reflux condenser, an inert gas inlet, and a thermometer was charged with a mixed solvent of 1-methoxy-2-propanol and toluene, and the temperature was raised to 80° C. under a nitrogen gas atmosphere. Methyl methacrylate/ethyl acrylate/methacrylic acid/2,2′-azobis(isobutyronitrile) was uniformly added dropwise at a mass ratio of 58/30/12/1 over 4 hours so that the amount of the resin in the resulting solution was 47.4% while maintaining the reaction temperature at 80° C.±2° C. After the dropwise addition, stirring was continued at 80° C.±2° C. for 6 hours to obtain an acrylic solution (A) (molecular weight: 135000).

### (Preparation of Polyacrylic Acid-Titanium Oxide Coating Liquid)

4 g of anatase-type titanium oxide (manufactured by FUJIFILM Wako Pure Chemical Corporation) and 17 g of the polyacrylic acid solution (A) (polyacrylic acid content: 8 g) were dissolved or dispersed in 19.2 g of ethyl acetate (solvent) to obtain a polyacrylic acid-titanium oxide coating liquid as a resin composition. Although titanium oxide precipitated over time, the polyacrylic acid-titanium oxide coating liquid was sufficiently stirred immediately before use to disperse titanium oxide, and used.

### (Preparation of Test Pad)

A test pad (HP69H, Resonac Corporation, pad area: 60 cm²) used for friction evaluation described later was prepared.

### Example 1

About 9 g of the titanium oxide coating liquid-1 was spray-coated without unevenness on the OUTER surface of the rotor (diameter 280 mm, thickness 28 mm, the same applies to the following Examples and Comparative Examples) preheated to about 80° C. Thereafter, the rotor was heated in a hot air dryer at about 180° C. for 30 minutes and left at room temperature. When the surface temperature decreased to about 80° C., about 9 g of the titanium oxide coating liquid-1 was spray-coated without unevenness on the INNER surface of the rotor. Thereafter, the rotor was heated in a hot air dryer at about 180° C. for 30 minutes. In this manner, a brake rotor of Example 1 was prepared.

### Example 2

About 9 g of the titanium oxide coating liquid-2 was spray-coated without unevenness on the OUTER surface of the rotor preheated to about 80° C. Thereafter, the rotor was heated in a hot air dryer at about 180° C. for 30 minutes and left at room temperature. When the surface temperature decreased to about 80° C., about 9 g of the titanium oxide coating liquid-2 was spray-coated without unevenness on the INNER surface of the rotor. Thereafter, the rotor was heated in a hot air dryer at about 180° C. for 30 minutes. In this manner, a brake rotor of Example 2 was prepared.

### Example 3

About 9 g of the titanium oxide coating liquid-3 was spray-coated without unevenness on the OUTER surface of the rotor preheated to about 80° C. Thereafter, the rotor was heated in a hot air dryer at about 180° C. for 30 minutes and left at room temperature. When the surface temperature decreased to about 80° C., about 9 g of the titanium oxide coating liquid-3 was spray-coated without unevenness on the INNER surface of the rotor. Thereafter, the rotor was heated in a hot air dryer at about 180° C. for 30 minutes. In this manner, a brake rotor of Example 3 was prepared.

### Comparative Example 1

About 8 g of the epoxy coating liquid was spray-coated without unevenness on the OUTER surface of the rotor preheated to about 80° C. Thereafter, the rotor was heated in a hot air dryer at about 180° C. for 30 minutes and left at room temperature. When the surface temperature decreased to about 80° C., about 8 g of the epoxy coating liquid was spray-coated without unevenness on the INNER surface of the rotor. Thereafter, the rotor was heated in a hot air dryer at about 180° C. for 30 minutes. In this manner, a brake rotor of Comparative Example 1 was prepared.

### Comparative Example 2

About 20 g of the polyacrylic acid-titanium oxide coating liquid was spray-coated without unevenness on the OUTER surface of the rotor. Thereafter, the rotor was heated in a hot air dryer at about 80° C. for 10 minutes, in a hot air dryer at about 100° C. for 10 minutes, in a hot air dryer at about 120° C. for 10 minutes, and left at room temperature. When the surface temperature decreased to room temperature, about 20 g of the polyacrylic acid-titanium oxide coating liquid was spray-coated without unevenness on the INNER surface of the rotor. Thereafter, the rotor was heated in a hot air dryer at about 80° C. for 10 minutes, in a hot air dryer at about 100° C. for 10 minutes, in a hot air dryer at about 120° C. for 10 minutes, and left at room temperature. In this manner, a brake rotor of Comparative Example 2 was prepared.

### Comparative Example 3

About 9 g of the titanium oxide coating liquid-4 was spray-coated without unevenness on the OUTER surface of the rotor preheated to about 80° C. Thereafter, the rotor was heated in a hot air dryer at about 180° C. for 30 minutes and left at room temperature. When the surface temperature decreased to about 80° C., about 9 g of the titanium oxide coating liquid-34 was spray-coated without unevenness on the INNER surface of the rotor. Thereafter, the rotor was heated in a hot air dryer at about 180° C. for 30 minutes. In this manner, a brake rotor of Comparative Example 3 was prepared.

### (Evaluation of Friction)

A friction evaluation test was performed under conditions of a temperature of 20° C. and a humidity of 60% using the above-described test pad, the brake rotor of each Example or each Comparative Example or an untreated rotor (diameter 280 mm, thickness 28 mm), and a brake dynamometer (manufactured by Shin Nippon Tokki Co., Ltd.).

Using the brake rotors of Examples 1 and 3, the brake rotors of Comparative Examples 2 and 3, and the untreated rotor, the brake test was repeated 100 times under the conditions of Table 1 to measure the friction coefficient. The results are shown in Table 1. In Comparative Example 2, since the fluctuation of the friction coefficient in one braking operation was 0.2 or more and the fluctuation of the friction coefficient was large, the friction coefficient could not be measured. In Comparative Example 3, the fluctuation of the friction coefficient in the brake was reduced from the tenth time, and the friction coefficient could be measured, whereas in the first time and the fifth time, the fluctuation of the friction coefficient in the brake was 0.2 or more, and the friction coefficient could not be measured.

Using the brake rotors of Example 1, Example 2, and Comparative Example 1 and the untreated rotor, the brake test was repeated 100 times under the conditions of Table 2 to measure the friction coefficient. The results are shown in Table 2. In Comparative Example 1, since the fluctuation of the friction coefficient in one brake was 0.2 or more and the fluctuation of the friction coefficient was large, the friction coefficient could not be measured.

TABLE 1

| | | | | | Comparative | Comparative |
|---|---|---|---|---|---|---|
| Rotor used | | Example 1 | Example 3 | Untreated | Example 2 | Example 3 |
| Test conditions | Initial speed | 60 | 60 | 60 | 60 | 60 |
| | (km/h) | | | | | |
| | Deceleration | 2.9 | 2.9 | 2.9 | 2.9 | 2.9 |
| | (m/s) | | | | | |
| Average friction | First time | 0.42 | 0.42 | 0.26 | Large | Large |
| coefficient with respect | | | | | fluctuation | fluctuation |
| to number of brakes | Fifth time | 0.40 | 0.45 | 0.28 | Large | Large |
| | | | | | fluctuation | fluctuation |
| | Tenth time | 0.37 | 0.36 | 0.37 | Large | 0.44 |
| | | | | | fluctuation | |
| | Fiftieth time | 0.39 | 0.45 | 0.45 | Large | 0.42 |
| | | | | | fluctuation | |

TABLE 2

| | | | | Comparative | |
|---|---|---|---|---|---|
| Rotor used | | Example 1 | Example 2 | Example 1 | Untreated |
| Test conditions | Initial speed (km/h) | 40 | 40 | 40 | 40 |
| | Deceleration (m/s) | 1.5 | 1.5 | 1.5 | 1.5 |
| Average friction | First time | 0.40 | 0.40 | Large fluctuation | 0.28 |
| coefficient with respect | Fifth time | 0.48 | 0.40 | Large fluctuation | 0.26 |
| to number of brakes | Tenth time | 0.48 | 0.42 | Large fluctuation | 0.25 |
| | Fiftieth time | 0.38 | 0.38 | Large fluctuation | 0.25 |

As shown in Table 1, in the brake rotors of Examples 1 and 3, the friction coefficient was high from the initial stage and the fluctuation of the friction coefficient when the number of brakes was increased was small as compared with those of the untreated rotor.

As shown in Table 2, in the brake rotors of Examples 1 and 2, the friction coefficient was high from the initial stage, and the fluctuation of the friction coefficient when the number of brakes was increased was relatively small and was within the allowable range. Even in a case in which the brake rotor of Example 1 was used and the test conditions were changed as shown in Tables 1 and 2, a stable friction coefficient could be obtained. From this, it is presumed that a stable friction coefficient can be obtained in Examples regardless of the state of the brake.

### (Rust Evaluation)

In the same manner as in Examples 1 to 3, cured films of titanium oxide coating liquids-1 to 3 having a thickness of about 25 μm were each formed on a cast iron (FC250) rotor ((64 mm). In a plastic case with an air hole in the upper part, each rotor was placed with the cured film facing upward via a 2 cm high spacer. Next, water was put into the plastic case so as to have a height of 1 cm, and the plastic case containing water was allowed to stand at room temperature conditioned at 23° C. The rust generation state on the rotor surface is shown in Table 3.

TABLE 3

| | | Titanium oxide | Titanium oxide | Titanium oxide | |
|---|---|---|---|---|---|
| Coating liquid | | coating liquid-1 | coating liquid-2 | coating liquid-3 | Untreated |
| Number of days | Initial | No rust | No rust | No rust | No rust |
| elapsed | After 1 day | No rust | No rust | No rust | Rusting |
| | After 5 days | No rust | No rust | No rust | Rusting |

From the results in Table 3, it was found that generation of rust was suppressed in the rotor coated with the titanium oxide coating liquid.

The disclosure of PCT/JP2023/034788 is incorporated herein by reference in its entirety.

All documents, patent applications, and technical standards described in this specification are incorporated herein by reference to the same extent as if each individual document, patent application, and technical standards were specifically and individually indicated to be incorporated herein by reference.

1. A resin composition for use in coating a sliding surface of a brake rotor, the resin composition comprising at least one compound selected from the group consisting of a titanium compound, a magnesium compound, and a lithium compound, and an epoxy resin or a precursor thereof,
wherein the epoxy resin or the precursor thereof has an epoxy equivalent of 900 g/eq or less.

2. The resin composition according to claim 1, wherein the compound is a titanium compound.

3. The resin composition according to claim 1, wherein the titanium compound is at least one selected from the group consisting of titanium oxide and titanium black.

4. The resin composition according to claim 1, wherein a content of the compound is from 25% by mass to 90% by mass with respect to a total solid content.

5. The resin composition according to claim 1, wherein the epoxy resin or the precursor thereof has an epoxy equivalent of 600 g/eq or less.

6. The resin composition according to claim 1, wherein the epoxy resin or the precursor thereof contains a bisphenol-type epoxy resin or a precursor thereof.

7. A brake rotor, comprising a sliding surface provided with a metal-containing layer formed from the resin composition according to claim 1.

8. A set for preparing a brake rotor, the set comprising:
at least one compound selected from the group consisting of a titanium compound, a magnesium compound, and a lithium compound,
an epoxy resin or a precursor thereof, and
a rotor member.

9. A method of producing a brake rotor using the set for preparing a brake rotor according to claim 8, the method comprising:
forming a metal-containing layer by applying a resin composition containing the compound and the epoxy resin or the precursor thereof to a sliding surface of the rotor member.

10. A brake, comprising the brake rotor according to claim 7 and a brake pad.

11. The brake according to claim 10, wherein the metal-containing layer has a thickness of from 1 μm to 100 μm.

12. The brake according to claim 10, wherein the brake rotor is made of cast iron, and is subjected to at least one surface treatment selected from grinding, polishing, or machining.

13. The brake according to claim 10, wherein the brake pad is a non-asbestos organic material pad.
